(19) United States
(12) Patent Application Publication
(10) Pub. No.: US 2020/0110387 A1
(43) Pub. Date: Apr. 9, 2020

(54) MACHINE TOOL AND AUTHENTICATION SYSTEM OF MACHINE TOOL

(71) Applicant: FANUC CORPORATION, Yamanashi (JP)

(72) Inventors: Shinichi TANAKA, Yamanashi (JP); Yuuzou INAGUCHI, Yamanashi (JP)

(73) Assignee: FANUC CORPORATION, Yamanashi (JP)

(21) Appl. No.: 16/556,027

(22) Filed: Aug. 29, 2019

(30) Foreign Application Priority Data
Oct. 5, 2018 (JP) 2018-190246

(51) Int. Cl. G05B 19/418; G05B 23/02

(52) U.S. Cl. CPC G05B 19/4183; G05B 19/4184; G05B 2219/24001; G05B 2219/24167; G05B 23/0283

(57) ABSTRACT

A machine tool includes a maintenance unit that can be replaced by a predetermined unit. The machine tool includes a monitoring section and a determination section. The monitoring section monitors a feature amount that gradually changes accompanying deterioration of the maintenance unit. The determination section determines whether the maintenance unit has been replaced on the basis of a trend of a change in the feature amount monitored by the monitoring section. With such a configuration, the machine tool is able to determine whether the maintenance unit has been replaced.

This application is based on and claims the benefit of priority from Japanese Patent Application No. 2018-190246, filed on 5 Oct, 2018, the content of which is incorporated herein by reference.

### BACKGROUND OF THE INVENTION

### Field of the Invention

The present invention relates to a machine tool and an authentication system of the machine tool.

### Related Art

A machine tool includes, for example, parts that require maintenance such as the spindle. For such a machine tool, a maintenance unit that can be replaced by a predetermined unit such as a spindle unit including a spindle is commercially available (for example, refer to Japanese Patent No. 4900677 and Japanese Unexamined Patent Application, Publication No. 2018-97494).

Patent Document 1: Japanese Patent No. 4900677

Patent Document 2: Japanese Unexamined Patent Application, Publication No. 2018-97494

### SUMMARY OF THE INVENTION

Since such a maintenance unit can be disassembled and examined by a third party, it is possible to manufacture a copy of a genuine product (unofficial product). When a maintenance person performs maintenance using such an unofficial product, it is highly likely that the original performance as a whole machine tool cannot be exhibited, particularly for a driven part such as a spindle.

It is desirable to automatically determine whether a maintenance unit has been replaced and whether the maintenance unit is a genuine product. However, neither of Japanese Patent No. 4900677 and Japanese Unexamined Patent Application, Publication No. 2018-97494 disclose a method of automatically determining whether a maintenance unit has been replaced.

It is an object to provide a machine tool that determines whether a maintenance unit has been replaced, and an authentication system of the machine tool.

(1) A machine tool (for example, a machine tool 1 described later) according to the present invention provided with a maintenance unit (for example, a spindle unit 16 described later) that can be replaced by a predetermined unit includes: a monitoring section (for example, monitoring section 22 described later) configured to monitor a feature amount that gradually changes accompanying deterioration of the maintenance unit; and a determination section (for example, a determination section 24 described later) configured to determine whether the maintenance unit has been replaced, on a basis of a trend of a change in the feature amount that is monitored by the monitoring section.

(2) In the machine tool described in (1), the feature amount may be information about the machine tool during operation.

(3) In the machine tool described in (2), the maintenance unit may be a unit including a driven part (for example, a spindle described later) that is coupled with and driven by a drive portion (for example, a spindle motor 14 described later) in the machine tool, and the information about the machine tool during operation may include information relating to load of the drive portion, or a value or waveform of drive current.

(4) In the machine tool described in any one of (1) to (3), the determination section may determine that the maintenance unit has been replaced in a case in which a change in the feature amount monitored by the monitoring section becomes a change in the opposite direction to the change accompanying the deterioration of the maintenance unit, or becomes a discontinuous change different from a continuous change accompanying the deterioration of the maintenance unit.

(5) The machine tool described in any one of (1) to (4) may further include: an ID tag (for example, an RFID tag 50 described later) attached to the maintenance unit and having identifier information of the maintenance unit; an ID reader (for example, an RFID reader 60 described later) reading identifier information of the ID tag; and a reading section (for example, a reading section 26 described later) using the ID reader to read the identifier information of the ID tag in the maintenance unit, in a case in which the determination section may determine that the maintenance unit has been replaced, in which the determination section may determine whether the maintenance unit is a genuine product on a basis of a reading result of the reading section.

(6) The machine tool described in (5) may further include: a restriction section (for example, a restriction section 28 described later) configured to restrict reuse of the ID tag by using the ID reader to write information indicating being used into the ID tag, in a case in which the identifier information of the ID tag is read by the reading section, and the determination section (24) determines that the maintenance unit is a genuine product.

(7) The machine tool described in (5) may further include a restriction section (for example, a restriction section 28 described later) configured to restrict operation of the machine tool, in a case in which the identifier information of the ID tag is not read by the reading section, and the determination section determines that the maintenance unit is an unofficial product.

(8) An authentication system (for example, an authentication system 100 described later) of a machine tool according to the present invention includes: a machine tool described in any one of (1) to (4); and an authentication device (for example, an authentication device 5) configured to perform authentication of a maintenance unit in the machine tool, and the machine tool requests a maintenance person to provide identifier information of the maintenance unit in a case in which the determination section determines that the maintenance unit has been replaced, and sends to the authentication device the identifier information of the maintenance unit inputted by the maintenance person, and the authentication device stores identifier information of a genuine product in advance, and performs authentication as to whether the maintenance unit is a genuine product on a basis of the identifier information of the maintenance unit received from the machine tool and identifier information of the genuine product that is stored.

(9) In the authentication system of the machine tool described in (8), in a case in which the authentication device authenticates that the maintenance unit is a genuine product, the authentication device may notify the machine tool of an authentication result, and restrict reuse of the identifier information by associating the identifier information of the maintenance unit with information indicating being used, and storing resultant information.

(10) In the authentication system described in (9), in a case in which the maintenance unit is an unofficial product, or in a case in which the maintenance unit is a genuine product but used, the authentication device may notify the machine tool of an authentication result therefrom, and the machine tool may restrict operation on a basis of the authentication result notified from the authentication device.

According to the present invention, it is possible to provide a machine tool that determines whether a maintenance unit has been replaced, and an authentication system of the machine tool.

### BRIEF DESCRIPTION OF THE DRAWINGS

FIG. 1 is a diagram illustrating the configuration of a machine tool according to the present embodiment;

FIG. 2 is a schematic diagram illustrating an example of a feature amount that gradually changes accompanying deterioration of a spindle in a machine tool;

FIG. 3 is a flow chart showing operation of a machine tool 1 according to the present embodiment; and

FIG. 4 is a diagram illustrating a configuration of an authentication system including a machine tool according to a modification example of the present embodiment.

### DETAILED DESCRIPTION OF THE INVENTION

In the following, an example of an embodiment of the present invention will be described with reference to the attached drawings. It should be noted that identical or corresponding portions in each drawing are accompanied with the same reference symbols.

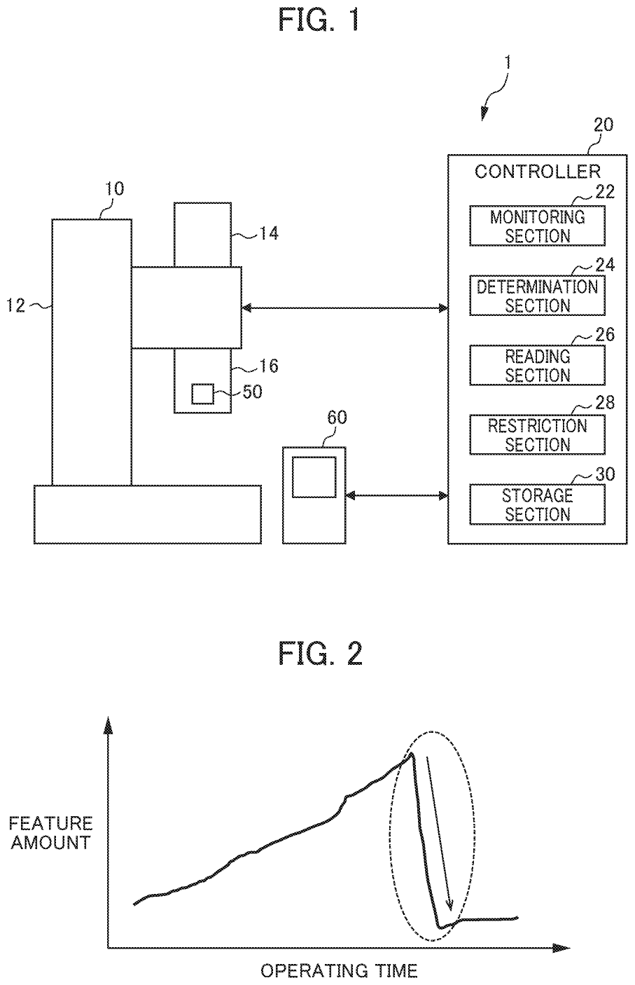

FIG. 1 is a diagram illustrating the configuration of a machine tool according to the present embodiment. The machine tool 1 illustrated in FIG. 1 includes a machine main body portion 10, a controller 20, an RFID tag (ID tag) 50, and an RFID reader (ID reader) 60.

The machine main body portion 10 includes a base body portion 12, a spindle motor (drive portion) 14, and a spindle unit (maintenance unit) 16 including a spindle (a driven part). The base body portion 12 holds the spindle motor 14 and the spindle unit 16. The base body portion 12 moves the spindle motor 14 and the spindle unit 16 by a feed axis motor (not shown). The spindle motor 14 is coupled to the spindle in the spindle unit 16 to rotationally drive the spindle. The spindle motor 14 and the feed axis motor in the machine main body portion 10 are controlled by a numerical control device (not shown) and a servo control device (not shown).

The spindle in the spindle unit 16 is a part that gradually deteriorates as the operating time increases. Therefore, the spindle unit 16 is a maintenance unit which can be replaced as a predetermined unit including the spindle. The spindle unit 16 includes an RFID tag (ID tag) 50 described later.

In the following, a spindle unit including a spindle is exemplified as the predetermined unit of the maintenance unit. However, the predetermined unit of the maintenance unit is not limited thereto, and may be a single part with only a spindle, for example. Furthermore, the spindle unit 16 including the spindle is exemplified as the maintenance unit in the following; however, the maintenance unit is not limited thereto, and may be a unit including a driven part that gradually deteriorates as the operating time increases, such as a feed axis. Furthermore, the maintenance unit may be a unit that includes a part other than the driven part that gradually deteriorates over time.

As described above, the RFID tag 50 is attached to the spindle unit 16. The RFID tag 50 includes identifier information of the spindle unit 16.

The RFID reader 60 may be attached to the machine main body portion 10, or may be separately arranged as a unit that can be connected to the machine main body portion 10. The RFID reader 60 reads the identifier information of the spindle unit 16 from the RFID tag 50 attached to the spindle unit 16 according to a command from the controller 20 described later.

The controller 20 includes a monitor section 22, a determination section 24, a reading section 26, a restriction section 28, and a storage section 30. The controller 20 may be mounted to the abovementioned numerical control device, or mounted to the servo control device.

The monitoring section 22 monitors a feature amount that gradually changes accompanying deterioration of the spindle in the spindle unit 16. For the driven part such as the spindle, there is information that gradually changes accompanying the deterioration when the machine tool is operated. For example, when the spindle of the machine tool is operated, the information relating to load and a drive current value of the spindle motor 14, the spectrum of a waveform thereof, or the like gradually changes (increases, in the present embodiment), accompanying the deterioration of the spindle (increase of the operating time), as illustrated in FIG. 2.

With such a configuration, the monitoring section 22 monitors, as the feature amount of the spindle unit 16, any one of these sets of information, or an integrated value of at least two of these sets of information. The monitoring section 22 may temporarily store, in the storage section 30, the feature amount of the spindle unit 16 to be monitored.

The determination section 24 determines whether the spindle unit 16 has been replaced, on the basis of a trend for change in the feature amount of the spindle unit 16 monitored by the monitoring section 22. If the spindle unit 16 has been replaced, as illustrated in FIG. 2, for example, the information relating to load and drive current value of the spindle motor 14, the spectrum of the waveform thereof, or the like changes (decreases, in the present embodiment) in the opposite direction to the change accompanying the deterioration of the spindle (increase of the operating time), or changes discontinuously (decreases, in the present embodiment) which differs from the continuous change accompanying the deterioration of the spindle (increase of the operating time) (the location enclosed with a circle in FIG. 2).

With such a configuration, the determination section 24 determines that the spindle unit 16 has been replaced in a case in which the change in the feature amount of the spindle unit 16 monitored by the monitoring section 22 becomes a change in the opposite direction to the change accompanying the deterioration of the spindle, or becomes a discontinuous change different from the continuous change accompanying the deterioration of the spindle.

Furthermore, the determination section 24 determines whether the spindle unit 16 is a genuine product (genuine product) on the basis of a reading result of the identifier information of the RFID tag 50 of the spindle unit 16 by the reading section 26 described later. More specifically, the determination section 24 determines that the spindle unit 16 is a genuine product in a case in which the identifier information of the RFID tag 50 of the spindle unit 16 is read by the reading section 26. On the contrary, in a case in which the identifier information of the RFID tag 50 of the spindle unit 16 is not read by the reading section 26, the determination section 24 determines that the spindle unit 16 is an unofficial product (copy of genuine product).

In a case in which the determination section 24 determines that the spindle unit 16 has been replaced, the reading section 26 uses the RFID reader 60 to read the identifier information of the spindle unit 16 from the RFID tag 50 attached to the spindle unit 16. At this time, the reading section 26 may automatically control the RFID reader 60, or alternatively, may request a reading operation with the RFID reader 60 performed manually by a maintenance person using, for example, a display device.

In a case in which the identifier information of the RFID tag 50 of the spindle unit 16 is read by the reading section 26, and the determination section 24 determines that the spindle unit 16 is a genuine product, the restriction section 28 uses the RFID reader 60 to write the information (for example, a flag) indicating being used in the RFID tag 50 attached to the spindle unit 16.

Here, it is anticipated that an RFID tag that was attached to a genuine product is being reused and this RFID is attached to an unofficial product. In regards to this, the restriction section 28 restricts so as to prevent the reuse of the RFID tag by writing the information indicating being used into the RFID tag 50 attached to the spindle unit 16. In the RFID tag, it is preferable for an area in which conducting the writing of the information indicating being used to be a write-once area.

Furthermore, in a case in which the identifier information of the RFID tag 50 of the spindle unit 16 is not read by the reading section 26, and the determination section 24 determines that the spindle unit 16 is an unofficial product (copy of a genuine product), the restriction section 28 restricts the operation of the machine tool 1. For example, the restriction section 28 may stop the operation of the machine tool 1 immediately. Alternatively, the restriction section 28 may perform warning on a display section (not shown), notify of an alarm, restrict the maximum speed of the spindle, or restrict the movement speed of the feed axis (restriction of operation), and then stop the machine tool 1 after a predetermined lapse of time.

The storage section 30 temporarily stores the feature amount of the spindle unit 16 that is monitored by the monitoring section 22. The storage section 30 is, for example, rewritable memory such as EEPROM. Furthermore, the storage section 30 stores predetermined software (programs) for realizing various types of functions of the controller 20.

The controller 20 (except for the storage section 30) is configured by an arithmetic processor such as a DSP (Digital Signal Processor) and FPGA (Field-Programmable Gate Array). The functions of the controller 20 (except for the storage section 30) are realized by executing the predetermined software (programs) stored in the storage section 30. The functions of the controller 20 (except for the storage section 30) may be realized by cooperation between hardware and software, or may be realized by only hardware (electronic circuit).

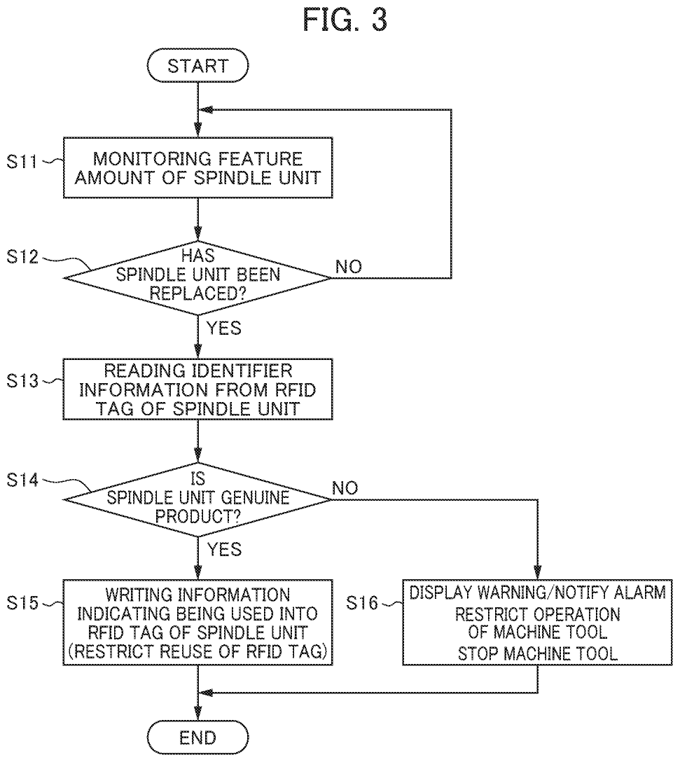

Next, with reference to FIG. 3, operations of the machine tool 1 according to the present embodiment will be described. FIG. 3 is a flowchart showing operation by the machine tool 1 according to the present embodiment.

First, the monitoring section 22 of the controller 20 monitors the feature amount that gradually changes accompanying deterioration of the spindle in the spindle unit 16 (S11). The monitoring section 22 monitors, as the feature amount of the spindle unit 16, any one set of the information relating to load and a drive current value of the spindle motor 14, the spectrum of a waveform thereof, or the like, or alternatively, an integrated value of at least two sets among these sets of information (for example, refer to FIG. 2). The monitoring section 22 may temporarily store, in the storage section 30, the feature amount of the spindle unit 16 that is monitored.

Next, the determination section 24 determines whether the spindle unit 16 has been replaced on the basis of the trend of the change in the feature amount of the spindle unit 16 monitored by the monitoring section 22 (S12). In a case in which the change in the feature amount of the spindle unit 16 monitored by the monitoring section 22 is a change in the opposite direction to the change accompanying the deterioration of the spindle, or a discontinuous change different from a continuous change accompanying the deterioration of the spindle, for example, the determination section 24 determines that the spindle unit 16 has been replaced (for example, refer to FIG. 2).

In a case in which the determination section 24 determines that the spindle unit 16 has not been replaced (NO in S12), the process returns to Step S11, and continues the monitoring of the feature amount of the spindle in the spindle unit 16.

On the other hand, in a case in which the determination section 24 determines that the spindle unit 16 has been replaced (YES in S12), the reading section 26 uses the RFID reader 60 to read the identifier information of the spindle unit 16 from the RFID tag 50 attached to the spindle unit 16 (S13).

Next, the determination section 24 determines whether the spindle unit 16 is a genuine product (genuine product) on the basis of a reading result of the identifier information of the RFID tag 50 of the spindle unit 16 by the reading section 26 (S14).

In a case in which the identifier information of the RFID tag 50 of the spindle unit 16 is read by the reading section 26, and the determination section 24 determines that the spindle unit 16 is a genuine product (YES in S14), the restriction section 28 uses the RFID reader 60 to write information (for example, a flag) indicating being used into the RFID tag 50 attached to the spindle unit 16 (S15). With such a configuration, the restriction section 28 restricts so as to prevent the reuse of the RFID tag.

On the other hand, in a case in which the identifier information of the RFID tag 50 of the spindle unit 16 is not read by the reading section 26, and the determination section 24 determines that the spindle unit 16 is an unofficial product (copy of genuine product) (NO in S14), the restriction section 28 restricts the operation of the machine tool 1 (S16). For example, the restriction section 28 may stop the operation of the machine tool 1 immediately. Alternatively, the restriction section 28 may perform warning on a display section (not illustrated), notify of an alarm, restrict the maximum speed of the spindle, or restrict the movement speed of a feed axis (restriction of operation), and then stop the machine tool 1 after a predetermined lapse of time.

As described above, according to the machine tool 1 of the present embodiment, it is possible to monitor the feature amount that gradually changes accompanying deterioration of the spindle and determine whether the spindle unit 16 has been replaced on the basis of the trend of the change in the monitored feature amount.

In the machine tool 1 of the present embodiment, in a case in which the replacement of a maintenance unit such as the spindle unit 16 is detected, the identifier information of a maintenance unit that had been attached by that time may be associated with the operation information thereof, and the resulting information may be automatically recorded within the controller of the machine tool. Furthermore, these sets of information may be stored in a server apparatus connected to the machine tool via a network, etc., and information in a plurality of machine tools may be centrally managed by the server apparatus (for example, FIELD system: FANUC Intelligent Edge Link & Drive system).

In such a case, the determination as to whether the maintenance unit has been replaced or not may be made in the server apparatus on the basis of various kinds of information that are centrally managed. In this case, as the feature amount based on which determining whether the maintenance unit has been replaced, a change in productivity (sharp improvement), a change in throughput (sharp improvement), a change in quality (sharp improvement), and the like may be employed.

### Modification Example

In the abovementioned embodiment, in a case in which it is detected that the spindle unit 16 has been replaced, the authentication as to whether the spindle unit 16 is a genuine product (genuine product) is made by using the RFID tag 50 and the RFID reader 60 with the machine tool 1 solely. However, the authentication as to whether the spindle unit 16 is a genuine product (genuine product) may be made by using an apparatus connected to the machine tool 1 via a network, etc.

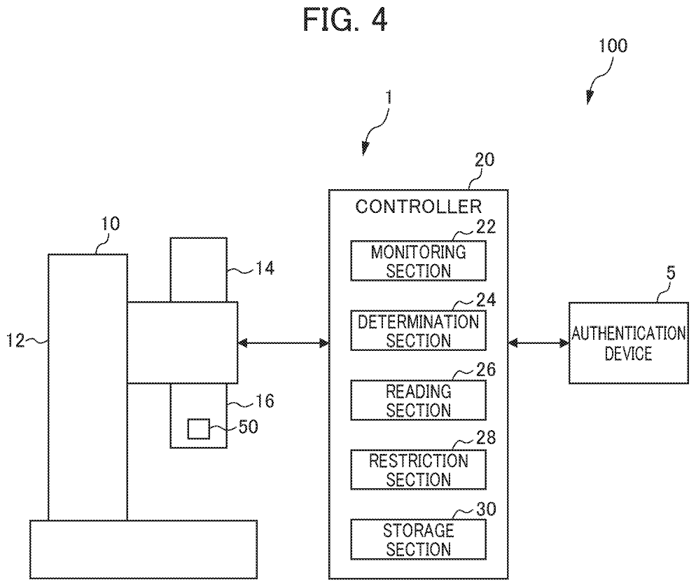

FIG. 4 is a diagram illustrating the configuration of an authentication system including a machine tool according to a modification example of the present embodiment. As illustrated in FIG. 4, an authentication system 100 includes a machine tool 1 of the modification example and an authentication device 5 connected to the machine tool 1 via a network, for example.

The machine tool 1 illustrated in FIG. 4 differs from that of the abovementioned embodiment in that the machine tool 1 illustrated in FIG. 4 does not include the RFID tag 50 and the RFID reader 60 of the machine tool 1 illustrated in FIG. 1. Furthermore, the machine tool 1 illustrated in FIG. 4 differs from that of the abovementioned embodiment in that, in the machine tool 1 illustrated in FIG. 4, the functions and the operations of the controller 20 differ in the machine tool 1 illustrated in FIG. 1.

In particular, in a case in which the determination section 24 determines that the spindle unit (maintenance unit) 16 has been replaced, the controller 20 (for example, the reading section 26) requests a maintenance person to provide the identifier information of the spindle unit 16. For example, the controller 20 uses, for example, a display device to request the maintenance person to provide the identifier information of the spindle unit 16. With such a configuration, the maintenance person inputs the serial number of the spindle unit 16 displayed on, for example, a sticker 55 attached to the spindle unit 16.

The controller 20 sends to the authentication device 5 the serial number (identifier information) of the spindle unit 16 inputted by the maintenance person. At this time, the controller 20 may send to the authentication device 5 the serial number (machine number) of the machine tool 1 that is stored in advance.

The authentication device 5 performs authentication of the spindle unit 16 in the machine tool 1. For example, the authentication device 5 is installed at the maker manufacturing the machine tool 1 and the spindle unit (maintenance unit) 16 as a genuine product, and stores in advance the serial number (machine number) of the machine tool 1, and the serial number (identifier information) of the spindle unit (maintenance unit) as a genuine product. The authentication device 5 performs authentication as to whether the spindle unit (maintenance unit) 16 is a genuine product or not on the basis of the serial number (identifier information) of the spindle unit (maintenance unit) 16 received from the machine tool 1 and the stored serial number (identifier information) of the genuine product.

In a case in which the authentication device 5 authenticates that the spindle unit (maintenance unit) 16 is a genuine product, the authentication device 5 notifies the machine tool 1 of an authentication result. Furthermore, in such a case, the authentication device 5 associates the serial number (identifier information) of the spindle unit (maintenance unit) 16 with information (for example, flag) indicating being used, and stores the resultant information. With such a configuration, the authentication device 5 restricts so as to prevent the reuse of the serial number (identifier information).

On the contrary, in a case in which the spindle unit (maintenance unit) 16 is an unofficial product, or in a case in which the spindle unit (maintenance unit) 16 is a genuine product but used, the authentication device 5 notifies the machine tool 1 of this authentication result. With such a configuration, the restriction section 28 of the controller 20 in the machine tool 1 restricts the operation of the machine tool 1 as described above on the basis of the authentication result notified from the authentication device 5. For example, the restriction section 28 may stop the operation of the machine tool 1 immediately. Alternatively, the restriction section 28 may perform a warning on a display section (not shown), notify of an alarm, restrict the maximum speed of the spindle, or restrict the movement speed of a feed axis (restriction of operation), and then stop the machine tool 1 after a predetermined lapse of time.

Although an embodiment of the present invention is described above, the present invention is not limited to the abovementioned embodiment, and various modifications and variations are possible. For example, a machine tool is exemplified in the abovementioned embodiment; however, the features of the present invention are not limited thereto, and can be applied to industrial machines including a maintenance unit (or a maintenance component) or various kinds of machines such as robots.

### EXPLANATION OF REFERENCE NUMERALS

1 machine tool
5 authentication device
10 machine main body portion
20 controller
12 base body portion
14 spindle motor (drive portion)
16 spindle unit (maintenance unit) including spindle (driven part)
22 monitoring section
24 determination section
26 reading section
28 restriction section
30 storage section
50 RFID tag (ID tag)
60 RFID reader (ID reader)
100 authentication system

What is claimed is:

1. A machine tool provided with a maintenance unit that can be replaced by a predetermined unit, the machine tool comprising:
a monitoring section monitoring a feature amount that gradually changes accompanying deterioration of the maintenance unit; and
a determination section determining whether the maintenance unit has been replaced, on a basis of a trend of a change in the feature amount that is monitored by the monitoring section.

2. The machine tool according to claim 1, wherein the feature amount comprises information about the machine tool during operation.

3. The machine tool according to claim 2, wherein the maintenance unit is a unit including a driven part that is coupled with and driven by a drive portion in the machine tool, and
the information about the machine tool during operation includes information relating to load of the drive portion, or a value or waveform of drive current.

4. The machine tool according to claim 1, wherein the determination section determines that the maintenance unit has been replaced in a case in which a change in the feature amount monitored by the monitoring section becomes a change in the opposite direction to the change accompanying the deterioration of the maintenance unit, or becomes a discontinuous change different from a continuous change accompanying the deterioration of the maintenance unit.

5. The machine tool according to claim 1, further comprising:
an ID tag attached to the maintenance unit and having identifier information of the maintenance unit;
an ID reader reading identifier information of the ID tag; and
a reading section using the ID reader to read the identifier information of the ID tag in the maintenance unit, in a case in which the determination section determines that the maintenance unit has been replaced,
wherein the determination section determines whether the maintenance unit is a genuine product on a basis of a reading result of the reading section.

6. The machine tool according to claim 5, further comprising a restriction section restricting reuse of the ID tag by using the ID reader to write information indicating being used into the ID tag, in a case in which the identifier information of the ID tag is read by the reading section, and the determination section determines that the maintenance unit is a genuine product.

7. The machine tool according to claim 5, further comprising a restriction section restricting operation of the machine tool, in a case in which the identifier information of the ID tag is not read by the reading section, and the determination section determines that the maintenance unit is an unofficial product.

8. An authentication system of a machine tool comprising:
a machine tool according to claim 1; and
an authentication device performing authentication of a maintenance unit in the machine tool,
wherein the machine tool
requests a maintenance person to provide identifier information of the maintenance unit in a case in which the determination section determines that the maintenance unit has been replaced, and
sends to the authentication device the identifier information of the maintenance unit inputted by the maintenance person,
wherein the authentication device
stores identifier information of a genuine product in advance, and
performs authentication as to whether the maintenance unit is a genuine product on a basis of the identifier information of the maintenance unit received from the machine tool and identifier information of the genuine product that is stored.

9. The authentication system of the machine tool according to claim 8, wherein, in a case in which the authentication device authenticates that the maintenance unit is a genuine product, the authentication device
notifies the machine tool of an authentication result, and
restricts reuse of the identifier information by associating the identifier information of the maintenance unit with information indicating being used, and storing resultant information.

10. The authentication system of the machine tool according to claim 9, wherein, in a case in which the maintenance unit is an unofficial product, or in a case in which the maintenance unit is a genuine product but used, the authentication device notifies the machine tool of an authentication result therefrom, and
the machine tool restricts operation on a basis of the authentication result notified from the authentication device.
